(19) United States
(12) Patent Application Publication
(10) Pub. No.: US 2022/0202529 A1
(43) Pub. Date: Jun. 30, 2022

(54) PROTECTIVE RUBBER DENTAL DAM BREATHING VENT

(71) Applicant: GIFTEDNESS AND CREATIVITY COMPANY, SAFAT (KW)

(72) Inventors: ALI ALTERKI, SAFAT (KW); FAISAL AMIR, SAFAT (KW); ABDULMOHSEN ALTERKI, SAFAT (KW); MOHAMMAD KAMAL, SAFAT (KW)

(21) Appl. No.: 17/561,240

(22) Filed: Dec. 23, 2021

Related U.S. Application Data
(60) Provisional application No. 63/130,841, filed on Dec. 27, 2020.

(51) Int. Cl. A61C 5/82

(52) U.S. Cl. CPC A61C 5/82

(57) ABSTRACT

A protective rubber dental dam breathing vent can assist patients to breathe more freely during a dental procedure without compromising the protective function of the rubber dental dam. The breathing vent includes a generally circular main body, a neck portion extending from an upper surface of the main body, and an opening defined through the main body and the neck portion. The main body includes an upper platform, a lower platform, and a groove between a lower surface of the upper platform and an upper surface of the lower platform. The breathing vent can be inserted through a slit in the rubber dam such that the rubber dam encircles the groove, the upper platform extends from one side of the rubber dam, and the lower platform extends from an opposite side of the rubber dental dam.

### CROSS-REFERENCE TO RELATED APPLICATION

This application claims the benefit of U.S. Provisional Patent Application Ser. No. 63/130,841, filed Dec. 27, 2020.

### BACKGROUND

1. Field

The disclosure of the present patent application relates to dental instruments, and particularly, to a protective rubber dental dam breathing vent.

2. Description of the Related Art

During a root canal and many other dental procedures, a health care professional will cover at least a portion of the patient's mouth with a rubber sheet widely referred to as a protective rubber dental dam (also referred to herein as a dental dam or rubber dam). Rubber dams are commonly sued for restorative dental work, such as amalgam and composites. Rubber dams are considered part of the standard of care for endodontic treatments.

The rubber dam is used to isolate a patient's tooth from other portions of the mouth of a patient during a dental procedure. The tooth protrudes through a small opening in the rubber dam, while the remaining teeth and mouth of the patient are covered by the rubber dam for protection.

Patients can have a difficult time breathing because rubber dams may prevent airflow through the mouth. Patients with medical conditions such as asthma, allergies, sinusitis, nasal obstructions, or psychological fears are particularly susceptible to breathing problems. This makes dental work more challenging for both the health care professional and the patient. These types of patients may refuse to seek the needed care rather than endure a procedure requiring the use of a rubber dam.

Thus, a rubber dental dam breathing vent solving the aforementioned problems is desired.

### SUMMARY

A protective rubber dental dam breathing vent can assist patients to breathe more freely during a dental procedure without compromising the protective function of the rubber dental dam. The breathing vent includes a generally circular main body, a neck portion extending from an upper surface of the main body, and an opening defined through the main body and the neck portion. The main body includes an upper platform, a lower platform, and a groove between a lower surface of the upper platform and an upper surface of the lower platform. The breathing vent can be inserted through a slit in the rubber dam such that the rubber dam encircles the groove, the upper platform extends from one side of the rubber dam, and the lower platform extends from an opposite side of the rubber dental dam. In use, air can pass from one side of the rubber dental dam to the other side of rubber dental dam through the opening in the breathing vent.

When using the protective rubber dental dam to isolate a tooth, the breathing vent can be inserted through the rubber dam to allow air to pass therethrough. In an embodiment, the neck portion of the breathing vent can be used to support dental instruments, such as an air line or a suction tube, and free the hand of the dental professional.

Sufficient air or oxygen can pass into the patient's mouth through the breathing vent without affecting the purpose of the rubber dam and without physically interfering with the ability of the dental professional to perform the dental procedure. Use of the breathing vent can increase the patient's comfort and lead to improved quality and better outcomes.

These and other features of the present subject matter will become readily apparent upon further review of the following specification.

### BRIEF DESCRIPTION OF THE DRAWINGS

FIG. 1 is a perspective view of the protective rubber dental dam breathing vent according to the present teachings.

FIG. 2 is a cross-sectional view of the protective rubber dental dam breathing vent according to the present teachings.

FIG. 3 is an environmental perspective view of the protective rubber dental dam breathing vent positioned in a dental dam according to the present teachings.

Similar reference characters denote corresponding features consistently throughout the attached drawings.

### DETAILED DESCRIPTION OF THE PREFERRED EMBODIMENTS

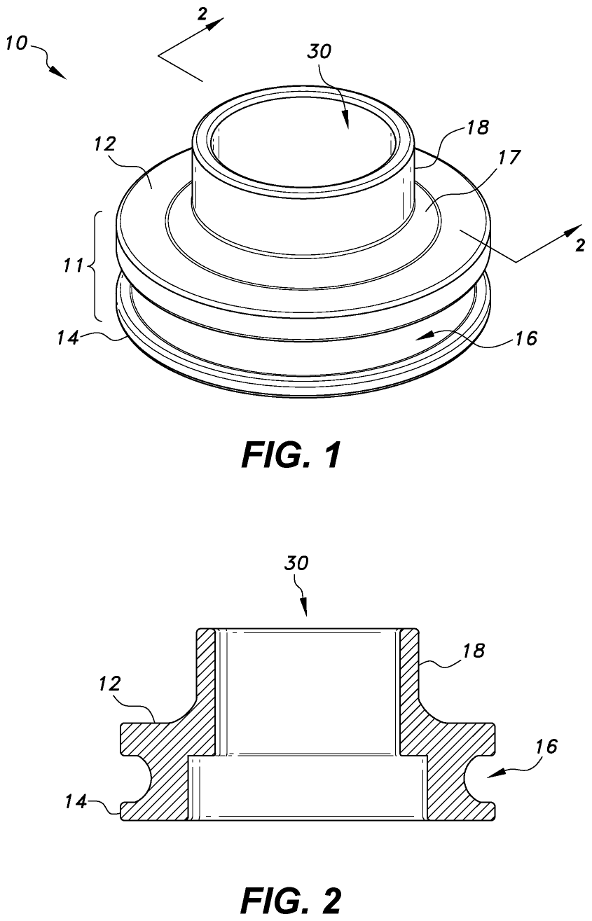

Referring to FIGS. 1-3, a protective rubber dental dam breathing vent 10 can include a generally circular main body 11 and an opening 30 defined through the main body 11. The breathing vent 10 can be inserted through a slit in a rubber dam RD to allow air to pass through the opening 30 during a dental procedure requiring use of the rubber dam RD.

As shown in FIGS. 1-2, the main body 11 includes an upper platform 12, a lower platform 14, and a first groove 16 defined between a lower surface of the upper platform 12 and an upper surface of the lower platform 14. In an embodiment, a neck portion 18 extends from an upper surface of the upper platform 12, and the opening 30 is defined through the main body 11 and the neck portion 18. A second groove 17 is defined around the neck portion 18 along an upper surface of the upper platform 12. The upper platform 12 and the lower platform 14 can be generally circular. In an embodiment, a diameter of the upper platform 12 can be the same as a diameter of the lower platform 14. In an embodiment, a diameter of the upper platform 12 can be different from a diameter of the lower platform 14.

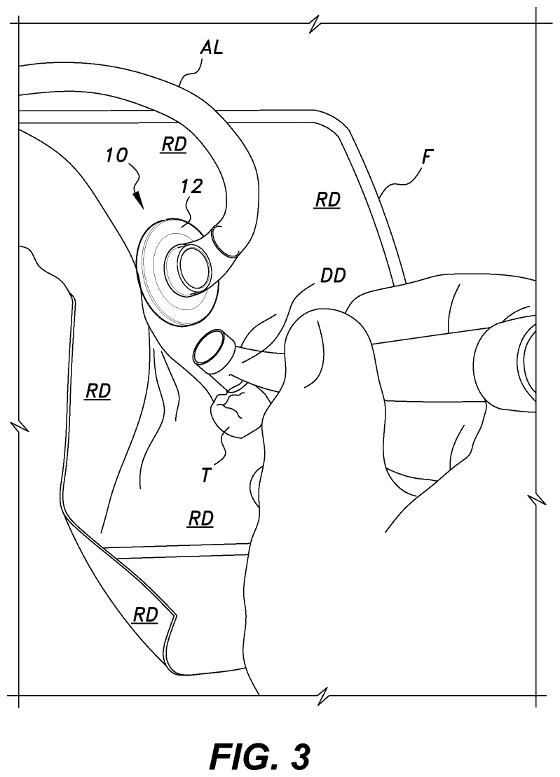

In use, a rubber dental dam RD can be positioned in the user's mouth to isolate a target tooth T and can be secured in place using a dental frame F, as is generally known and depicted in FIG. 3. The dental professional can then cut a slit in the rubber dental dam RD and push the breathing vent 10 through the slit such that the rubber dental dam RD edges formed by the slit fit snugly within the first groove 16 and create a seal (FIG. 3). Once positioned in the rubber dental dam RD, the upper platform 12 of the breathing vent 10 extends from one side of the rubber dam RD, and the lower platform 14 extends from an opposite side of the rubber dental dam RD, thereby providing a rigid and controlled opening through the rubber dam RD through which air may pass into the patient's mouth. The neck portion 30 can provide a rigid support or guide for dental instruments, such as a suction tube or an airline AL, to be inserted into the patient's mouth. In an embodiment, a portion of the vent 10, e.g., the neck portion 30, can be connected to an airline AL connector or a threaded or compression style fitting to which air delivery tubing such as an airline AL can be securely attached to ensure adequate air or gas supply for breathing. The dental professional can then work on the isolated tooth T with an appropriate dental device DD.

The breathing vent 10 can be used for both adult and child patients and can be manufactured inexpensively. The breathing vent 10 can be made from plastic, metal, glass, ceramic, rubber, or other suitable material or combination of materials. The breathing vent 10 can be reusable with proper sterilization or individually packed for a single use. The breathing vent can be formed from an integral piece or from multiple rigidly or removably connected parts.

The protective rubber dental dam breathing vent can assist all dental patients to breathe more freely during a dental procedure without compromising the protective function of the rubber dental dam. When using the protective rubber dental dam to isolate a tooth, the breathing vent can be inserted through the rubber dam to allow air to pass through the opening of the breathing vent. The neck portion of the breathing vent can be used to support dental instruments, such as an airline or a suction tube, and free the hand of the dental professional.

Sufficient air or oxygen can pass into the patient's mouth through the breathing vent without affecting the purpose of the rubber dam and without physically interfering with the ability of the dental professional to perform the dental procedure. Use of the breathing vent can increase the patient's comfort and lead to improved quality and better outcomes.

It is to be understood that the protective rubber dental dam breathing vent is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A protective rubber dental dam breathing vent, comprising:
a main body including an upper platform, a lower platform spaced from the upper platform, and a main groove defined in the space between the upper platform and the lower platform; and
an opening defined through the main body.

2. The breathing vent as recited in claim 1, wherein the main body is generally circular

3. The breathing vent as recited in claim 2, wherein a diameter of the upper platform and the lower platform are different.

4. The breathing vent as recited in claim 2, wherein a diameter of the upper platform and a diameter of the lower platform are the same.

5. The breathing vent as recited in claim 1, further comprising an upright neck portion extending from an upper surface of the upper platform, the neck portion including an opening aligned with the opening of the main body.

6. The breathing vent as recited in claim 5, wherein a second groove is formed along the upper surface of the upper platform around the neck portion.

7. A breathing vent for a protective rubber dental dam, comprising:
a generally circular main body including an upper platform, a lower platform spaced from the upper platform, and a main groove defined in the space between the upper platform and the lower platform;
an upright neck portion extending from an upper portion of the main body; and
an opening defined through the main body and the neck portion.

8. The breathing vent for a protective rubber dam as recited in claim 7, wherein a diameter of the upper platform and the lower platform are the same.

9. The breathing vent for a protective rubber dam as recited in claim 7, wherein a diameter of the upper platform and the lower platform are different.

10. The breathing vent as recited in claim 9, wherein a second groove is formed along the upper surface of the upper platform around the neck portion.
